(19) United States
(12) Patent Application Publication
(10) Pub. No.: US 2014/0347316 A1
(43) Pub. Date: Nov. 27, 2014

(54) TOUCH DEVICE AND MEASURING VOLTAGE DYNAMIC ADJUSTMENT METHOD THEREOF

(71) Applicant: ELAN MICROELECTRONICS CORPORATION, Hsinchu (TW)

(72) Inventors: I-Hau YEH, Taipei City (TW); Bo-Syuan HUANG, Taichung City (TW); Hsueh-Wei YANG, Zhubei City (TW); Yung Lieh CHIEN, Taoyuan County (TW)

(73) Assignee: ELAN MICROELECTRONICS CORPORATION, Hsinchu (TW)

(21) Appl. No.: 14/212,634

(22) Filed: Mar. 14, 2014

(30) Foreign Application Priority Data
May 21, 2013 (TW) 102117864

(51) Int. Cl. G06F 3/044; G06F 3/0354

(52) U.S. Cl. CPC G06F 3/044; G06F 3/03545
USPC 345/174

(57) ABSTRACT

A touch device and a measuring voltage dynamic adjustment method thereof are provided. The touch device comprises a touch panel, a touch sensing circuit and a processing unit. The touch sensing circuit electrically connected to the touch panel is configured to provide a first measuring voltage to the touch panel and sense capacitance variation of the touch panel to generate a plurality of sensing signals. The processing unit electrically connected to the touch sensing circuit is configured to receive the sensing signals, determine whether a touch is caused by a stylus according to the sensing signals and if yes, enable the touch sensing circuit to provide a second measuring voltage to the touch panel. The second measuring voltage is larger than the first measuring voltage.

This application claims the benefit of priority based on Taiwan Patent Application No. 102117864 filed on May 21, 2013, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a touch device and a measuring voltage dynamic adjustment method thereof, and more particularly, relates to a touch device capable of determining the kind of an object on the touch panel according to the sensing signals and dynamically adjusting a measuring voltage according to the determination result.

2. Descriptions of the Related Art

In recent years, touch devices (e.g., personal digital assistants (PDAs), tablet computers, digital video cameras, information appliances, mobile phones and etc) have found wide application in people's daily life. Users can operate the touch devices simply through touching. For touch panels of the touch devices, capacitive touch panels are widely used.

In addition to operating a touch device by using a finger to touch the touch panel, a user may also operate the touch device by using a stylus to touch the touch panel. However, capacitance variation caused by a finger's touch and that caused by a stylus' touch are different from each other, and specifically, the capacitance variation caused by the stylus is relatively small. Therefore, when an invariable measuring voltage that is generally designed for a finger's touch is provided to the touch panel in case of a stylus' touch, inconveniences in operation are often caused because the capacitance variation generated by the stylus is not greater than a threshold for determining a touch. To solve this problem, a scheme in which a higher invariable measuring voltage is provided to the touch panel has been proposed by some manufacturers. Although this can effectively increase the capacitance variation caused by the stylus, the power consumption of the touch panel becomes higher.

Accordingly, an urgent need exists in the art to provide a solution that, when a stylus is used to operate a touch device, can provide an appropriate measuring voltage so that the touch device can accurately determine occurrence of the touch according to the capacitance variation caused by the stylus and, meanwhile, can prevent an excessive increase of the power consumption.

### SUMMARY OF THE INVENTION

An objective of the present invention is to provide a mechanism of dynamically adjusting a measuring voltage, which dynamically adjusts the measuring voltage by determining whether a touch panel is touched by a stylus. Thereby, the touch device can accurately determine occurrence of the touch according to the capacitance variation caused by the stylus and, meanwhile, can prevent an excessive increase of the power consumption.

To achieve the aforesaid objective, the present invention discloses a touch device. The touch device comprises a touch panel, a touch sensing circuit and a processing unit. The touch sensing circuit electrically connected to the touch panel is configured to provide a first measuring voltage to the touch panel and sense capacitance variation of the touch panel to generate a plurality of sensing signals. The processing unit electrically connected to the touch sensing circuit is configured to receive the sensing signals, determine whether a touch is caused by a stylus according to the sensing signals and if yes, enable the touch sensing circuit to provide a second measuring voltage to the touch panel. The second measuring voltage is greater than the first measuring voltage.

The present invention further discloses a measuring voltage dynamic adjustment method for a touch device. The measuring voltage dynamic adjustment method comprises the following steps of: (a) enabling a touch sensing circuit to provide a first measuring voltage to a touch panel; (b) receiving a plurality of sensing signals from the touch sensing circuit; (c) determining whether a touch is caused by a stylus according to the sensing signals; and (d) if the touch is caused by the stylus, then enabling the touch sensing circuit to provide a second measuring voltage to the touch panel, wherein the second measuring voltage is greater than the first measuring voltage.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a touch device 1 according to the present invention;

FIG. 2A is a diagram illustrating relationships among a touch region A1, a first position P1, a second position P2 and a position difference PV;

FIG. 2B is a diagram illustrating relationships among a maximum sensing signal SM, a scaled sensing signal SP, a sensing signal difference SV and the position difference PV; and

FIG. 3 is a flowchart diagram of a measuring voltage dynamic adjustment method according to a second embodiment of the present invention.

### DESCRIPTION OF THE PREFERRED EMBODIMENT

It shall be appreciated that, the following embodiments are only intended to exemplify the technical contents of the present invention, but not to limit the scope of the present invention. Furthermore, in the following embodiments and attached drawings, elements unrelated to the present invention are omitted from depiction; and dimensional relationships among the individual elements in the attached drawings are illustrated only for the ease of understanding, but not to limit the actual scale.

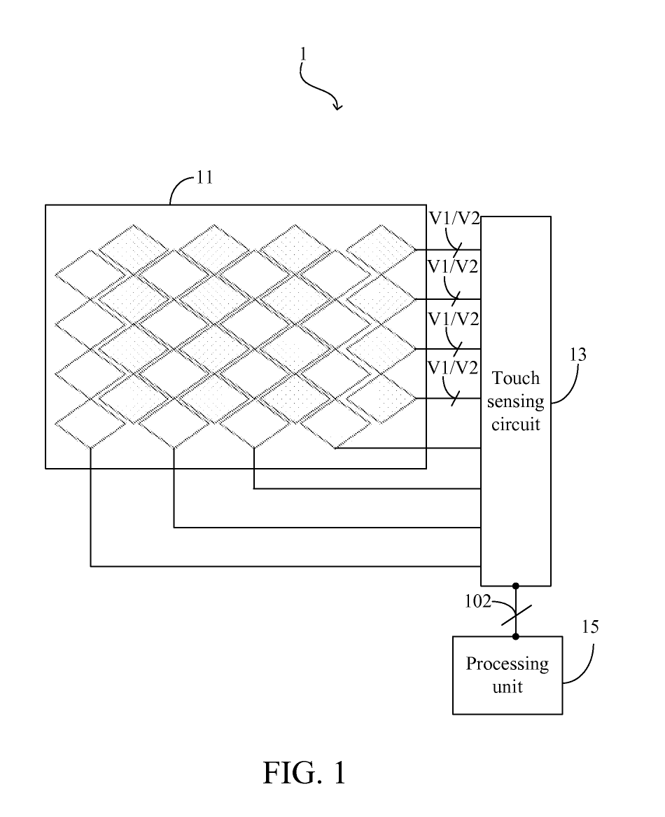

FIG. 1 depicts a touch device 1 according to a first embodiment of the present invention, which may be a mobile phone, a personal digital assistant (PDA), a tablet computer, an external touch panel, or any other device with a touch function. The touch device 1 comprises a touch panel 11, a touch sensing circuit 13 and a processing unit 15. It should be appreciated that, for simplicity of description, other elements of the touch device 1 (e.g., a communication module, an input module, a power supply module and elements unrelated to the present invention) are omitted from depiction.

The touch sensing circuit 13 is electrically connected to the touch panel 11 and the processing unit 15. The touch sensing circuit 13 provides a first measuring voltage V1 to the touch panel 11 and senses capacitance variation of the touch panel 11 to generate a plurality of sensing signals 102. In the present invention, the magnitude of each of the sensing signals 102 can represent an amount of variation in capacitance caused by touching the touch panel 11.

Specifically, the touch sensing circuit 13 continuously scans the touch panel 11 to sense the capacitance variation on the touch panel 11 in response to a touch from an object (e.g., a finger or a stylus). The sensing signals 102 may be generated according to the capacitance variation corresponding to a plurality of continuous positions on the touch panel 11 and each position may be sensed by one or more times during a sensing period based on the practical design. How to generate the sensing signals 102 by sensing the capacitance variation on the touch panel 11 will be readily appreciated by those of ordinary skill in the art, and thus will not be further described herein.

The processing unit 15 receives the sensing signals 102 and determines whether a touch object on the touch panel 11 is a stylus according to the sensing signals 102 (i.e., determines whether the capacitance variation of the touch panel 11 is caused by the stylus). If the touch object is the stylus, then the processing unit 15 enables the touch sensing circuit 13 to provide a second measuring voltage V2 to the touch panel 11.

Specifically, the second measuring voltage V2 is greater than the first measuring voltage V1. After determining that a user is using the stylus to operate the touch device 1 according to the sensing signals 102, the processing unit 15 enables the touch sensing circuit 13 to provide the second measuring voltage V2 to the touch panel 11. In this way, when the second measuring voltage V2 is provided to the touch panel 11, the processing unit 15 can accurately determine a touch caused by the stylus, thereby reducing the influence of noises on position determination.

How the processing unit 15 determines whether the capacitance variation of the touch panel 11 is caused by the stylus will be exemplified below. However, the present invention is not limited to this way of determination, and as can be readily appreciated by those of ordinary skill in the art, whether the capacitance variation of the touch panel 11 is caused by the stylus can be determined in numerous other different ways, which will not be further described herein.

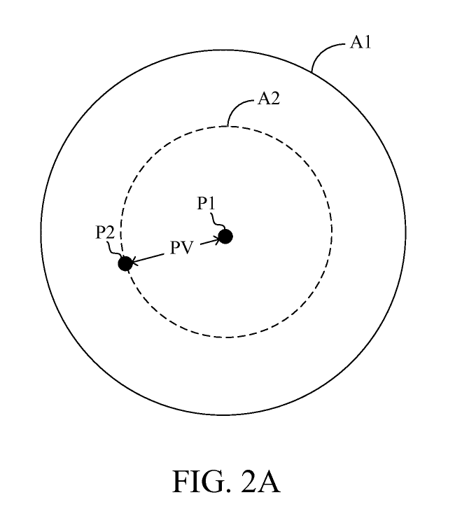

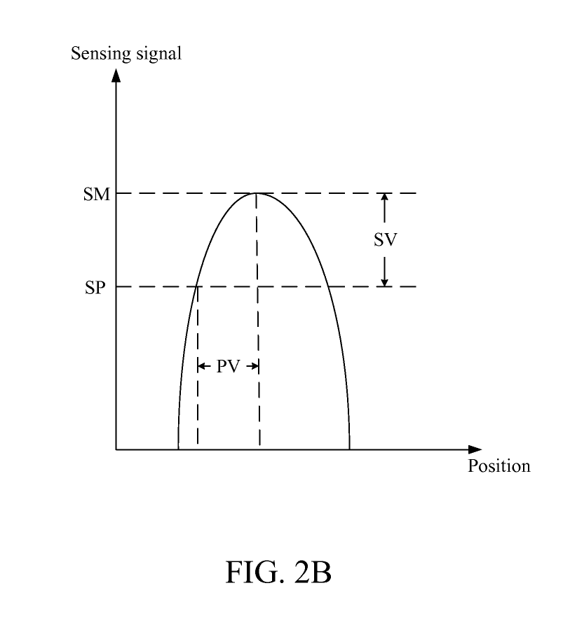

As shown in FIG. 2A, the processing unit 15 can determine a touch region A1 on the touch panel 11 according to the sensing signals 102 (i.e., according to the amount of variation in capacitance). In detail, the processing unit 15 determines the touch region A1 by determining that sensing signals 102 corresponding to a plurality of continuous positions on the touch panel 11 are all greater than a threshold. The touch region A1 represents a region where capacitance variation is caused by an electrically conductive object touching the touch panel 11. Subsequently, the processing unit 15 retrieves a maximum sensing signal SM from the sensing signals 102 corresponding to the touch region A1 and retrieves a first position P1 corresponding to the maximum sensing signal SM. Then, the processing unit 15 multiplies the maximum sensing signal SM with a preset ratio (e.g., 60%) to obtain a preset value SP. A determined region A2 indicated by the dotted line can be further determined within the touch region A1 according to the preset value SP. Sensing signals within the determined region A2 are greater than or equal to the preset value SP. Then, distances from positions at a boundary of the determined region A2 to the first position P1 are compared with each other, and a position at the boundary of the determined region A2 which is nearest to the first position P1 is determined as a second position P2.

Further referring to FIG. 2B, after the first position P1 and the second position P2 have been determined, the processing unit 15 calculates a sensing signal difference SV between the maximum sensing signal SM and the scaled sensing signal SP of the touch region A1, and a position difference PV between the first position P1 and the second position P2. Finally, the processing unit 15 determines whether the touch on the touch region A1 is caused by the stylus according to a ratio R of the sensing signal difference SV to the position difference PV of the touch region A1. In detail, the ratio R may be SV/PV. A region on the touch panel 11 touched by the stylus is smaller than that touched by a finger, so if the ratio R is greater than a preset value, then the processing unit 15 can determine that the capacitance variation of the touch region A1 is caused by the stylus. Otherwise, if the ratio R is smaller than the preset value, then the processing unit 15 can determine that the capacitance variation of the touch region A1 is caused by a finger.

It should be appreciated that, the processing unit 15 may determine a plurality of touch regions according to the sensing signals 102, and a touch in each of the touch regions may all be determined in the aforesaid way of determining whether the touch of the touch region A1 is caused by the stylus. If the touch in any of the touch regions is determined to be caused by the stylus, then the processing unit 15 enables the touch sensing circuit 13 to provide the second measuring voltage V2 to the touch panel 11. As the implementation related to a plurality of touch regions can be readily appreciated by those of ordinary skill in the art based on the above descriptions, it will not be further described herein.

On the other hand, when the touch sensing circuit 13 provides the second measuring voltage V2 to the touch panel 11, the processing unit 15 further determines whether the next touch is caused by the stylus according to the sensing signals 102. If the next touch is not caused by the stylus, then the touch sensing circuit 13 is enabled to provide the first measuring voltage V1 to the touch panel 11. In other words, when the user does not operate the touch device 1 by touching the touch panel 11 with the stylus, the processing unit 15 enables the touch sensing circuit 13 to provide the first measuring voltage V1 which is smaller to the touch panel 11 to prevent an excessive increase of the power consumption.

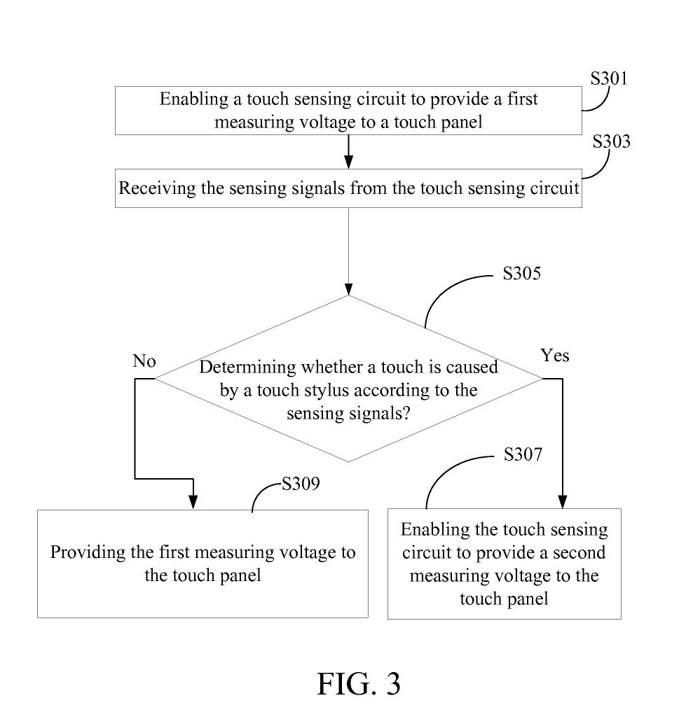

A second embodiment of the present invention is a measuring voltage dynamic adjustment method, a flowchart diagram of which is shown in FIG. 3. The measuring voltage dynamic adjustment method of the present invention is adapted for the processing unit 15 of the touch device 1 according to the first embodiment. The measuring voltage dynamic adjustment method of the present invention is for use in a touch device having a touch panel, a touch sensing circuit and a processing unit (e.g., the touch device 1 of the first embodiment). The measuring voltage dynamic adjustment method described in this embodiment is executed by the processing unit of the touch device.

Firstly, in step S301, a touch sensing circuit is enabled to provide a first measuring voltage to a touch panel. In step S303, the sensing signals are received from the touch sensing circuit. Subsequently in step S305, it is determined whether a touch is caused by a stylus according to the sensing signals. If the touch is caused by the stylus, then step S307 is executed to enable the touch sensing circuit to provide a second measuring voltage to the touch panel. The second measuring voltage is greater than the first measuring voltage. Otherwise, if the touch is not caused by the stylus, then step S309 is executed to provide the first measuring voltage to the touch panel. In detail, when the step S309 is executed, the first measuring voltage is continuously provided if the touch sensing circuit is currently providing the first measuring voltage to the touch panel; and the touch sensing circuit is enabled to provide the first measuring voltage to the touch panel if the touch sensing circuit is currently providing the second measuring voltage to the touch panel instead.

In addition to the aforesaid steps, the second embodiment can also execute all the operations and functions set forth in the first embodiment. How the measuring voltage dynamic adjustment method for a touch device according to the present invention executes these operations and functions will be readily appreciated by those of ordinary skill in the art based on the explanation of the first embodiment, and thus will not be further described herein.

According to the above descriptions, the touch device and the measuring voltage dynamic adjustment method of the present invention dynamically adjust the measuring voltage by determining whether the user operates the touch device with the stylus according to the sensing signals generated by the touch sensing circuit. Thereby, as compared with the conventional touch devices, the touch device of the present invention can accurately determine occurrence of the touch according to the capacitance variation caused by the stylus and, meanwhile, can prevent an excessive increase of the power consumption.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A touch device, comprising:
a touch panel;
a touch sensing circuit electrically connected to the touch panel, being configured to provide a first measuring voltage to the touch panel and sense capacitance variation of the touch panel to generate a plurality of sensing signals; and
a processing unit electrically connected to the touch sensing circuit, being configured to receive the sensing signals, determine whether a touch is caused by a stylus according to the sensing signals and, if yes, enable the touch sensing circuit to provide a second measuring voltage to the touch panel, wherein the second measuring voltage is greater than the first measuring voltage.

2. The touch device as claimed in claim 1, wherein the processing unit further executes the following operations:
determining at least one touch region on the touch panel according to the sensing signals, wherein the sensing signals corresponding to the at least one touch region is greater than a threshold;
for each of the at least one touch region:
retrieving a maximum sensing signal from the sensing signals and a first position corresponding to the maximum sensing signal;
multiplying the maximum sensing signal with a preset ratio to obtain a scaled sensing signal;
obtaining a determined region according to the scaled sensing signal, wherein the sensing signals corresponding to the determined region is greater than or equal to the scaled sensing signal;
selecting a second position at a boundary of the determined region; and
calculating a sensing signal difference between the maximum sensing signal and the scaled sensing signal, and a position difference between the first position and the second position; and
determining whether the touch is caused by the stylus according to a ratio of the sensing signal difference to the position difference of each of the at least one touch region.

3. The touch device as claimed in claim 1, wherein when the second measuring voltage is provided to the touch panel, the processing unit further executes the following operations:
determining whether another touch is caused by the stylus according to the sensing signals; and
if not, then enabling the touch sensing circuit to provide the first measuring voltage to the touch panel.

4. The touch device as claimed in claim 1, wherein the touch device is one of a mobile phone, a personal digital assistant (PDA), a tablet computer and an external touch pad.

5. A measuring voltage dynamic adjustment method for a touch device, comprising the following steps of:
(a) enabling a touch sensing circuit to provide a first measuring voltage to a touch panel;
(b) receiving a plurality of sensing signals from the touch sensing circuit;
(c) determining whether a touch is caused by a stylus according to the sensing signals; and
(d) if the touch is caused by the stylus, then enabling the touch sensing circuit to provide a second measuring voltage to the touch panel, wherein the second measuring voltage is greater than the first measuring voltage.

6. The measuring voltage dynamic adjustment method as claimed in claim 5, wherein the touch panel is a capacitive touch panel, and the step (c) further comprises the following steps of:
determining at least one touch region on the touch panel according to the sensing signals, wherein the sensing signals corresponding to at least one touch region is greater than a threshold;
for each of the at least one touch region:
retrieving a maximum sensing signal from the sensing signals and a first position corresponding to the maximum sensing signal;
multiplying the maximum sensing signal with a preset ratio to obtain a scaled sensing signal;
obtaining a determined region according to the scaled sensing signal, wherein the sensing signals corresponding to the determined region is greater than or equal to the scaled sensing signal;
selecting a second position at a boundary of the determined region; and
calculating a sensing signal difference between the maximum sensing signal and the scaled sensing signal, and a position difference between the first position and the second position; and
determining that the stylus is on the touch panel according to a ratio of the sensing signal difference to the position difference of each of the at least one touch region.

7. The measuring voltage dynamic adjustment method as claimed in claim 5, further comprising the following steps when the second measuring voltage is provided to the touch panel:
determining whether another touch is caused by the stylus according to the sensing signals; and
if the another touch is not caused by the stylus, then enabling the touch sensing circuit to provide the first measuring voltage to the touch panel.

8. The measuring voltage dynamic adjustment method as claimed in claim 5, wherein the touch device is one of a mobile phone, a personal digital assistant (PDA), a tablet computer and an external touch pad.
